(19) United States
(12) Patent Application Publication
(10) Pub. No.: US 2024/0052233 A1
(43) Pub. Date: Feb. 15, 2024

(54) CEMENT SLURRY WITH POLYETHYLENEIMINE HYDROCHLORIDE SALT AS A SHALE INHIBITOR

(71) Applicant: Saudi Arabian Oil Company, Dhahran (SA)

(72) Inventors: Vikrant Wagle, Dhahran (SA); Ali Mohammed Hussain Al Safran, Dhahran (SA); Abdullah Saleh Hussain Al-Yami, Dhahran (SA); Omprakash Pal, Dhahran (SA); Abdulaziz AlHehal, Al Hofuf (SA)

(21) Appl. No.: 17/879,215

(22) Filed: Aug. 2, 2022

(51) Int. Cl. C09K 8/48; C09K 8/42; C04B 28/04; C04B 22/12; C04B 24/04

(52) U.S. Cl. CPC C09K 8/48; C09K 8/424; C04B 28/04; C04B 22/124; C04B 24/04; C04B 2103/50

(57) ABSTRACT

A cement composition and methods for preparing and using the cement composition are provided. The cement composition includes a polyethyleneimine hydrochloride (PEI HCl) salt, an aqueous solvent, and a cement.

### TECHNICAL FIELD

The present disclosure is directed to the use of cement in wells that have shale, or other hydratable materials.

### BACKGROUND

The production of crude oil and gas generally involves placing cement, for example, around casing in a wellbore, as part of the well completion. Good cementing plays an essential role in oil and gas wells. It has various and important functions such as providing wellbore integrity, supporting the vertical and radial loads applied to the casing, and isolating the formations from the producing zone. A failed cement job and subsequent loss of zonal isolation can have a negative effect at the cement-formation interface, in the bulk cement, and at the casing-cement interface.

One of the primary concerns in the oil and gas industry is the incompatibility of cement and shale and the subsequent failure of primary cementing jobs. This incompatibility can be due to the interaction of the cement filtrate with the shale formation thereby subsequently resulting it its swelling. This may lead to an increased risk in failing to isolate zones thereby presenting a well control hazard and subsequent sustained casing pressure.

### SUMMARY

An embodiment described in examples herein provides a method for cementing in a wellbore. The method includes making a cement slurry by reacting a polyethyleneimine (PEI) with hydrochloric acid to form a polyethyleneimine hydrochloride (PEI HCl) salt, dissolving the PEI HCl salt in water to form a PEI HCl salt solution, and mixing the PEI HCl salt solution with cement to form a cement slurry. The cement slurry in injected in a wellbore, and allowed to set.

Another embodiment described in examples herein provides a cement composition for cementing a wellbore. The cement composition includes a polyethyleneimine hydrochloride (PEI HCl) salt, an aqueous solvent, and a cement.

Another embodiment described in examples herein provides a method for making a cement slurry. The method includes reacting a polyethyleneimine (PEI) with hydrochloric acid to form a polyethyleneimine hydrochloride (PEI HCl) salt, dissolving the PEI HCl salt in water to form a PEI HCl salt solution, and mixing the PEI HCl salt solution with cement to form a cement slurry.

### BRIEF DESCRIPTION OF DRAWINGS

FIGS. 1A and 1B are schematic drawings of a cementing operation in a wellbore that has a shale layer.

FIG. 2 is a process flow diagram of a method for performing a cementing operation using a polyethyleneimine hydrochloride (PEI HCl) salt as a shale inhibitor in the cement composition.

FIGS. 3A to 3E are examples of PEI structures that may be used to form PEI HCl salts for shale inhibitors.

FIG. 4A is a schematic diagram of a reaction for forming a PEI HCl salt.

FIG. 4B is a structural diagram of a PEI HCl salt.

FIG. 5 is a plot that shows the effect of increasing polyethylene polyamine salt concentration on the rheology of the bentonite dispersions at 120° F.

FIG. 6 are drawings of the shale cuttings after performing the shale erosion tests.

### DETAILED DESCRIPTION

Shale inhibitors are often added to aqueous compositions used in well drilling and completion operations to avoid problems with hydration of shale layers. For example, potassium chloride can be added to aqueous compositions to inhibit water adsorption and collapse of shale layers.

Compositions and methods provided herein describe the synthesis and use of a high molecular weight polyethyleneimine hydrochloride (PEI HCl) salt as a shale inhibitor for a cement slurry. The PEI HCl salt has the general structure:

[H₂NCH₂CH₂(NHCH₂CH₂)ₓN H₂]·HCl,

where x is 3, 4, 5, or higher. In some embodiments, x is 100. A comparison of a conventional potassium chloride shale inhibitor with the PEI HCl salt indicates that the PEI HCl salt has a higher performance as a shale inhibitor as compared to a potassium chloride shale inhibitor.

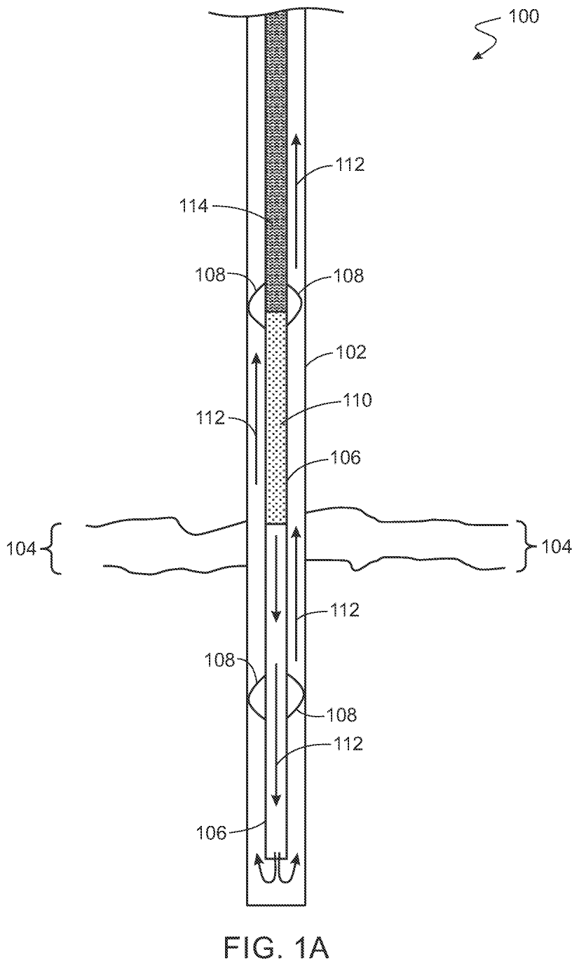

FIGS. 1A and 1B are schematic drawings of a cementing operation 100 in a wellbore 102 that has a shale layer 104. In this example, a casing tubular 106 is placed inside the wellbore 102. The proportions of the casing tubular 106 and the wellbore 102 are not shown to scale to make it easier to see the cementing operation 100. Further, other devices may be used in addition, or in place of, the devices shown in this example. For example, the downhole end of the casing tubular 106 may have a shoe, or device with a rounded end, to direct the casing tubular 106 down the wellbore 102, while preventing the casing tubular 106 from getting caught on the rough walls of the wellbore 102.

Centralizers 108 are generally used to center the casing tubular 106 in the wellbore 102. Once the casing tubular 106 is in place, the cementing job is performed. For example, a cement spacer fluid 110 is injected into the casing tubular 106 to separate the drilling mud 112 from the cement slurry 114 that is injected. The cement spacer fluid 110 is generally used as the cement slurry 114 is often not compatible with the drilling mud 112, and would form a gel at the interface between the drilling mud 112 and the cement slurry 114. For example, the drilling mud 112 may be an invert emulsion that has a non-aqueous continuous phase. In contrast, the cement spacer fluid 110 and the cement slurry 114 are generally aqueous, and may hydrate the shale layer 104 causing a portion of the surface to flake off into the wellbore 102. The shale inhibitors described herein may mitigate this problem.

As shown in FIG. 1B, the cement spacer fluid 110, followed by the cement slurry 114, exits the casing tubular 106 and moves up the annulus between the casing tubular 106 and the wellbore 102. A displacement fluid 116 is used to force the cement out of the casing tubular 106 and into the annulus. The displacement fluid 116 may be an aqueous fluid with a composition similar to the spacer fluid. In some embodiments, a displacement fluid 116 is not used, and an elastomeric plug, termed a wiper plug, is used to force the cement slurry 114 out of the casing tubular 106.

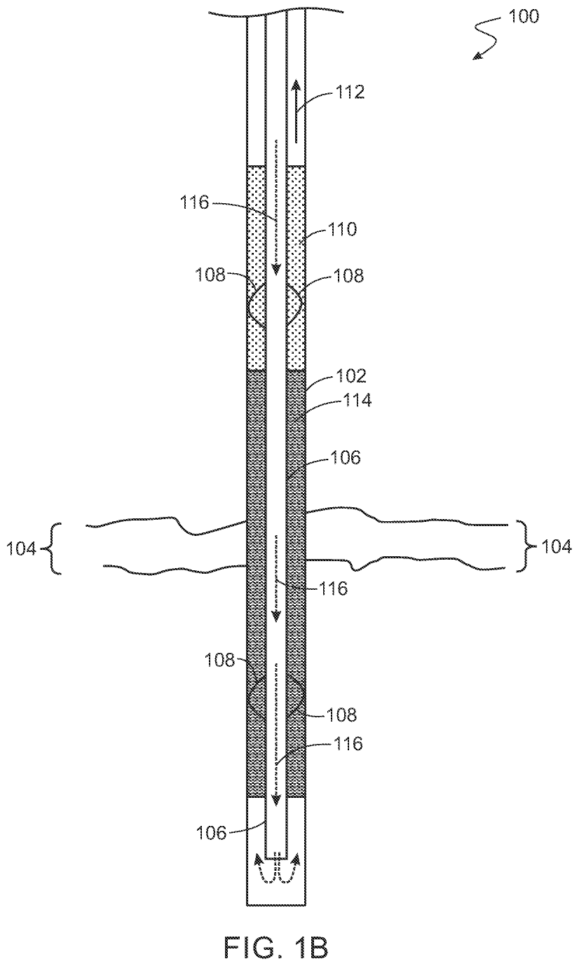

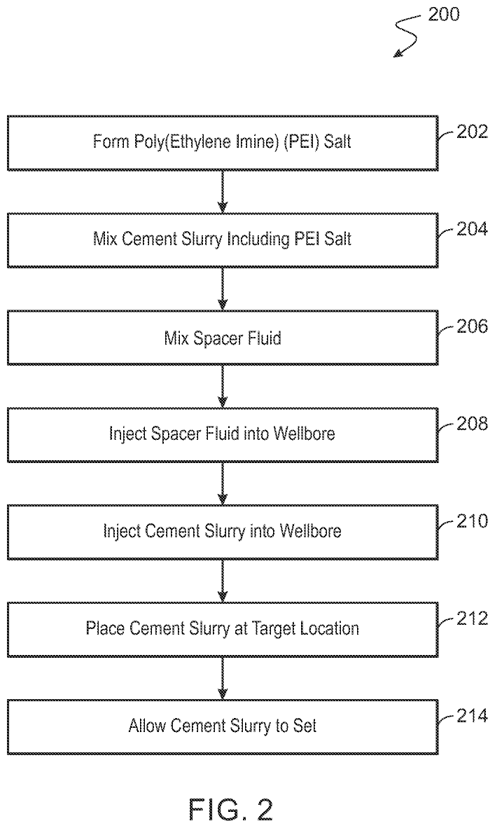

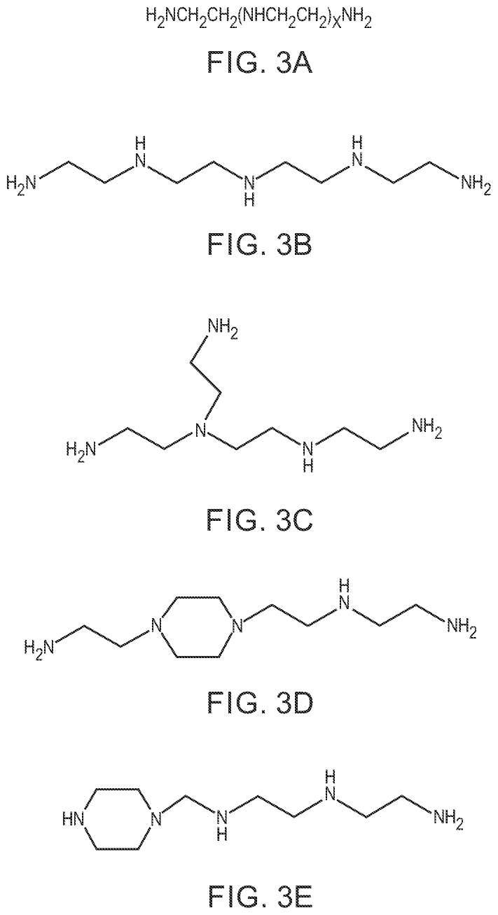

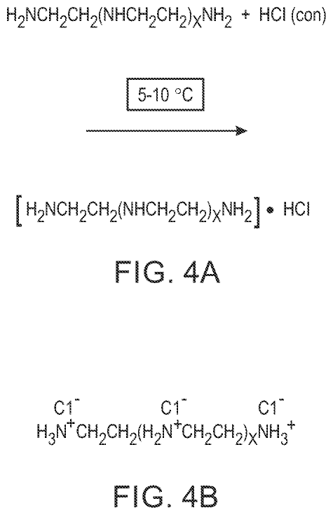

FIG. 2 is a process flow diagram of a method 200 for performing a cementing operation using a polyethyleneimine hydrochloride (PEI HCl) salt as a shale inhibitor in the cement composition. The method 200 starts at block 202 with the formation of the PEI HCl salt. This is performed by reacting a PEI, for example, as shown in FIGS. 3A-3E, with concentrated hydrochloric acid. The reaction is performed as described with respect to FIG. 4A, with a resulting general structure as shown in FIG. 4B.

At block 204, a cement slurry is formed that includes the PEI HCl salt. As described further with respect to the examples, this may be performed by mixing the PEI HCl salt with water and other materials, such as defoaming agents, to form a base aqueous solution. The PEI HCl salt makes up about 0.5 wt. % to about 30 wt. % of the cement slurry. The cement can then be added to the base aqueous solution to the base aqueous solution to form the cement slurry. In various embodiments, the cement makes up about 10 wt. % to about 90 wt. % of the cement slurry. In various embodiments, the cement includes class A, class B, class C, class G, and class H cement. Other additives that may be added include accelerators, retarders, extenders, suspending agents, weighting agents, fluid loss control agents, lost circulation control agents, surfactants, antifoaming agents, or combinations of these. The setting time of the cement with the PEI HCl salt may be adjusted by the addition of accelerants or retarders.

At block 206, the spacer fluid is mixed up. The spacer fluid may be an aqueous fluid, for example, including a shale inhibitor, an antifoaming agent, and the like. In some embodiments, the spacer fluid includes the PEI HCl salt as a shale inhibitor.

At block 208, the spacer fluid is injected into the casing tubular to force out drilling mud. The spacer fluid injection may be after other fluids that are injected before the spacer fluid, such as a chemical wash to clean the surfaces of the wellbore in preparation for the cementing.

At block 210, the cement slurry is injected into the wellbore after the spacer fluid. In some embodiments, the cement slurry is separated from the spacer fluid by a wiper plug.

At block 212, the cement slurry is placed at the target location, for example, overlapping the centralizers and filling the annulus between the wellbore and the casing tubular. The amount of cement slurry injected may be determined by the volume of the annulus between the tubular casing and the wellbore.

At block 214, the cement slurry is allowed to set. Once the cement surrounding the first casing tubular has set, drilling of the wellbore may continue. Once a target distance is reached, for example, 500 m, 1000 m, or longer depending on the structure of the subsurface layers and aquifers, a smaller diameter casing tubular is inserted. The cementing is then repeated to place cement in the annulus between the smaller casing tubular and the wellbore and in the annulus between the smaller casing tubular and the first casing tubular.

### Examples

Synthesis of Polyethyleneimine Hydrochloride (PEI HCl) Salt

FIGS. 3A to 3E are examples of PEI structures that may be used to form PEI HCl salts for shale inhibitors. The polyethyleneimine (PEI) tested was ethylene amine E-100, obtained from Arabian Amines Company of Jubail Industrial City, Saudi Arabia. E-100 is a complex mixture of various linear, cyclic, and branched products with a number-average molecular weight of 250-300 g/mole with the general structure shown in FIG. 3A. In FIG. 3A, x is 3, 4, 5, or higher. For example, E-100 may include tetraethylenepentamine (TEPA), pentaethylenehexamine (PEHA), hexaethylene-heptamine (HEHA), and higher molecular weight products. Once of the primary constituents of E-100 is tetraethylenepentamine, which has the structure shown in FIG. 3B. Other TEPA isomers may also be present, such as AETETA (4-(2-aminoethyl)-N-(2-aminoethyl)-N′-{2-{(2-aminoethyl)amino}ethyl}-1,2-ethanediamine), shown in FIG. 3C, AEPEEDA (1-(2-aminoethyl)-4-[(2-aminoethyl)-amino]ethyl]-piperazine), shown in FIG. 3D, and PEDETA (1-[2-[[2-[(2-aminoethyl)amino]ethyl]-amino]ethyl]-piperazine), shown in FIG. 3E.

FIG. 4A is a schematic diagram of a reaction scheme for forming a PEI HCl salt. As shown in the reaction scheme, the PEI is reacted with concentrated HCl at a reduced temperature. For example, 133 ml of E-100 was placed in a beaker. The beaker was kept at a temperature between 5-10° C. in an ice water bath. 130 ml of 12.1N concentrated hydrochloric acid was added to the polyamine in increments of 0.5 ml with constant stirring, for example, using a glass rod. The HCl (con) was continuously added until the pH of the PEI HCl salt solution reached 7.5. At the end of the HCl addition, a 68-70% w/w aqueous solution of PEI hydrochloride salt was obtained. The PEI HCl salt obtained may have the general structure shown in FIG. 4B. In FIGS. 4A and 4B, x is 3, 4, 5, or higher.

Performance of PEI HCl salt based shale inhibitor in cement slurries.

The performance of a PEI HCl salt as a shale inhibitor was evaluated by performing three tests, including a hydration suppression test, a shale erosion test, and a rheology test on the cement slurry.

Hydration suppression test.

Reactive shales in contact with cement tend to swell, as they are susceptible to hydration. Shale inhibitors tend to suppress the hydration, thereby preventing the swelling of the shale. Thus, to check the efficacy of the PEI HCl salt as a shale inhibitor, hydration suppression tests were performed using bentonite clay as a model of the shale.

Bentonite clay is extremely susceptible to hydration. When bentonite clay becomes hydrated, its volume expands greatly as it absorbs more and more water between the plates of its structure. A corresponding increase in fluid viscosity accompanies this hydration. One way to measure the hydration suppression characteristics of an inhibitor is to compare the viscosity of a fluid containing bentonite and an inhibitor to a fluid with just bentonite.

To determine the performance of PEI HCl salt as a shale inhibitor, hydration suppression tests were performed using water, bentonite, and increasing concentrations of PEI HCl salt. The additives, their concentrations, and order of mixing is given in Table 1. After mixing the additives, the aqueous bentonite dispersions were hot rolled at 150° F. (66° C.) for 16 hours. After hot rolling, the rheology of the dispersions was measured at 120° F. (49° C.) with the results shown in Table 1.

TABLE 1
Hydration suppression tests of PEI hydrochloride salt shale inhibitor

| Additive | Mix time | Fluid 1 | Fluid 2 | Fluid 3 | Fluid 4 |
|---|---|---|---|---|---|
| Water, g | | 350 | 350 | 350 | 350 |
| E-100 salt, g | 5 | 0 | 1 | 5 | 10 |
| API Bentonite, g | 20 | 30 | 30 | 30 | 30 |

Rheology, 120º F. (49° C.)

| | | | | |
|---|---|---|---|---|
| 600 | 121 | 42 | 19 | 6 |
| 300 | 86 | 28 | 15 | 3 |
| 200 | 72 | 21 | 13 | 2 |
| 100 | 52 | 14 | 11 | 2 |
| 6 | 12 | 5 | 7 | 0 |
| 3 | 9 | 4 | 7 | 0 |
| PV, centipoise (cp) | 35 | 14 | 4 | 3 |
| YP, lbs./100 ft² | 51 | 14 | 11 | 0 |
| (0.049 kg/m²) | | | | |
| 10 sec Gel strength, | 9 | 8 | 7 | 1 |
| lbs./100 ft² | | | | |
| (0.049 kg/m²) | | | | |
| 10 min Gel strength, | 28 | 17 | 9 | 2 |
| lbs./100 ft² | | | | |
| (0.049 kg/m²) | | | | |

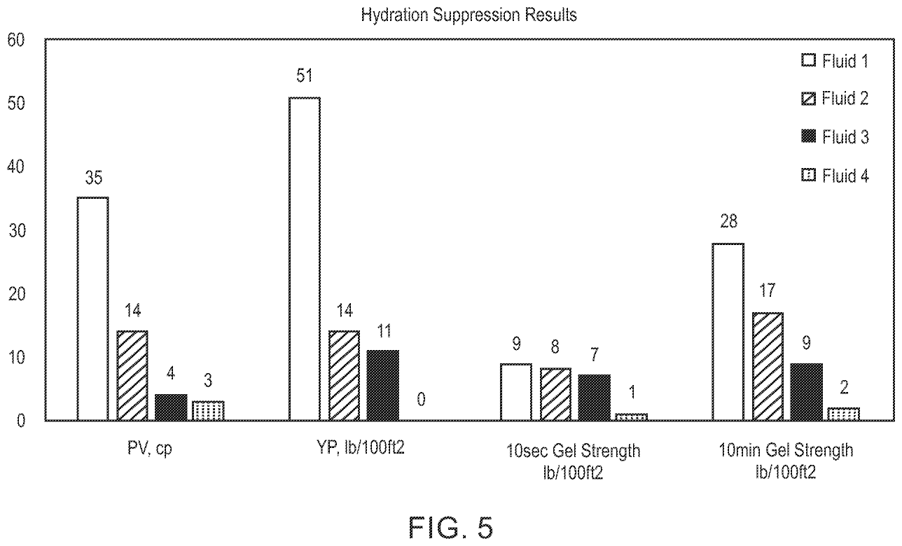

In the absence of the PEI HCl salt, as shown for Fluid 1, the bentonite dispersion showed a YP value of 51 at 120° F. However, addition of the PEI HCl salt to the dispersions, suppresses the hydration of bentonite in water thereby resulting in lower YP values, as shown for Fluids 2, 3, and 4. FIG. 5 is a plot that shows the effect of increasing polyethylene polyamine salt concentration on the rheology of the bentonite dispersions at 120° F. These hydration tests therefore show that PEI HCl salt can be an effective shale inhibitor when used in cement slurries.

Shale Erosion Tests

The shale-erosion test is used to measure the dispersive effect that a cement will have on a specific type of shale. The following procedures were used for the shale erosion tests.

Cement Slurry Formulation:

Three different cement slurries were formulated with densities of 117pcf. Table 2 gives the formulation of the three cement slurries. Slurry 1 has no shale inhibitor. Slurry 2 includes a conventional KCl shale inhibitor. Slurry 3 includes the PEI HCl salt.

TABLE 2
gives the formulation of three cement slurries

| Additive | Slurry 1 | Slurry 2 | Slurry 3 |
|---|---|---|---|
| Water, g | 352 | 352 | 352 |
| Defoamer, g | Few drops | Few drops | Few drops |
| Cement, g | 800 | 800 | 800 |
| KCl, g | — | 15 | — |
| PEI HCl salt, g | — | — | 15 |

Mixing the Cement Slurry

The mixing procedure to formulate the cement slurry was performed by adding defoamer to the water while stirring at 1000 rpm, for example, using a lab mixer. The shale inhibitor, either KCl or the PEI HCl salt, was then added while stirring at 1000 rpm for two minutes. The speed of the mixer was raised to 4000 rpm and the cement was added. Immediately after the cement was added, the speed of the mixer was raised to 12000 rpm for 30 seconds.

Collecting the Cement Filtrate for Shale Erosion Tests

A cement filtrate was used to perform the shale erosion tests. The objective of the shale erosion tests was to check the effect of the cement filtrate on the shale. During cementing a shale formation, the cement filtrate can contact the shale and cause it to swell. The swelling may lead to poor cement-shale formation bonding, and a potential loss of well integrity. The cement filtrate was collected by performing the fluid loss test.

The fluid loss test was performed by placing a filter medium (325 mesh screen) at the bottom of a fluid loss cell. The prepared cement slurry was placed in the fluid loss cell, and the cell was pressured up to 1000 psi. A valve was opened at the bottom of the cell and the cement filtrate coming out was collected and measured. The fluid loss test was repeated with a fresh aliquot of the cement until a total of 350 ml of filtrate was collected. The 350 ml of filtrate was used in the shale erosion test.

Shale Erosion Test Procedure

Cuttings were prepared using shale from the Qusaiba formation of central Saudi Arabia. The cuttings were sized by passing through a 4-mesh sieve and retained on a 5-mesh sieve. 350 ml of the cement filtrate were added to a hot rolling cell and 20 grams of the sized shale were added with the cement filtrate. The hot rolling cell was hot rolled at 150° F. for 16 hours.

After the hot rolling was completed, the shale cuttings were recovered by pouring the cement filtrate from the hot rolling cell onto the 5-mesh sieve. The cuttings were then carefully washed with 5% w/w KCl brine, and removed from the sieve. The samples were placed in an oven at 105° C., and left overnight to dry. The dried samples were weighed, and the % recovery was calculated based on sample recovered:

% shale recovery=(weight of recovered shale cuttings/20)*100

The results for the shale erosion tests are given in Table 3.

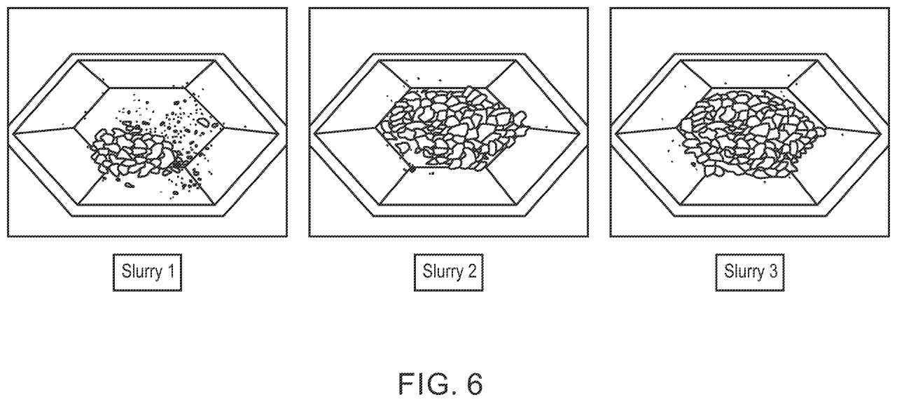

The results showed that the cement slurry with the PEI HCl salt (slurry 3) gave better shale recovery as compared to the cement slurry formulated with the conventional KCl shale inhibitor (slurry 2). FIG. 6 are drawings of the shale cuttings after performing the shale erosion tests.

TABLE 3
Shale erosion test results

| | Shale |
|---|---|
| Fluids | recovery % |
| Slurry 1 | 6.5 |
| Slurry 2 | 39.7 |
| Slurry 3 | 54.8 |

Rheology of Cement Slurry

The effect of the PEI HCl salt on the rheology of a 117 pcf (1874.16 kg/m 3) cement slurry was studied. The rheology of the three slurries of Table 3 was measured using a Fann Model 35 viscometer at 25° C. (77° F.), with the results shown in Table 4. The test procedure used was “API RP10B-2 Recommended Practice for Testing Well Cements.” The viscometer is available from the Fann Instrument Company of Houston, TX.

TABLE 4
Shale erosion test results

| | | Slurry 1 | | Slurry 2 | | Slurry 3 | |
|---|---|---|---|---|---|---|---|
| (rpm) | unit | UP | Down | UP | Down | UP | Down |
| 300 | lbs./100 ft² | 80.4 | 80.4 | 92 | 92 | 97.5 | 97.5 |
| 200 | lbs./100 ft² | 69 | 73 | 82.5 | 77.4 | 86.9 | 85.6 |
| 100 | lbs./100 ft² | 55.4 | 61.3 | 66.1 | 65.7 | 69.1 | 75 |
| 60 | lbs./100 ft² | 47.6 | 55.8 | 59.7 | 60.2 | 60.8 | 70.1 |
| 30 | lbs./100 ft² | 39.9 | 49.4 | 51.7 | 54.4 | 55.6 | 63.9 |
| 6 | lbs./100 ft² | 17.2 | 34.5 | 21.8 | 39 | 23.5 | 32 |
| 3 | lbs./100 ft² | 9.2 | 16.9 | 13.8 | 24 | 15.3 | 22.9 |

| | | | | |
|---|---|---|---|---|
| 10 sec | lbs./100 ft² | 15.7 | 17.1 | 19.9 |
| gel | | | | |
| 10 min | lbs./100 ft² | 17 | 17.6 | 21.1 |
| gel | | | | |

The rheology values of the three slurries were comparatively similar. Thus, it can be concluded that polyethylene polyamine salt did not have any adverse effect on the rheology of the cement slurry.

### Embodiments

An embodiment described in examples herein provides a method for cementing in a wellbore. The method includes making a cement slurry by reacting a polyethyleneimine (PEI) with hydrochloric acid to form a polyethyleneimine hydrochloride (PEI HCl) salt, dissolving the PEI HCl salt in water to form a PEI HCl salt solution, and mixing the PEI HCl salt solution with cement to form a cement slurry. The cement slurry in injected in a wellbore, and allowed to set.

In an aspect, the method includes reacting the PEI with a stoichiometric amount of concentrated hydrochloric acid.

In an aspect, the method includes injecting a spacer fluid into the wellbore before the cement slurry. In an aspect, the method includes adding the PEI HCl salt to the space fluid before injecting the spacer fluid into the wellbore.

In an aspect, the method includes adding potassium chloride to the cement slurry.

In an aspect, the method includes injecting a displacement fluid after the cement slurry.

In an aspect, the method includes placing a wiper plug in the wellbore after the cement slurry and before a displacement fluid.

Another embodiment described in examples herein provides a cement composition for cementing a wellbore. The cement composition includes a polyethyleneimine hydrochloride (PEI HCl) salt, an aqueous solvent, and a cement.

In an aspect, the cement composition includes between about 0.5 wt. % of the PEI HCl salt and about 30 wt. % of the PEI HCl salt.

In an aspect, the cement composition includes between 10 wt. % of the cement and about 90 wt. % of the cement. In an aspect, the cement includes a Portland cement.

In an aspect, the cement composition includes between about 68 wt. % and 69 wt. % of the cement.

In an aspect, the cement composition includes a defoaming agent.

In an aspect, the cement composition includes a polyethyleneimine hydrochloride (PEI HCl) salt having the structural formula:

[H₂NCH₂CH₂(NHCH₂CH₂)ₓNH₂]·HCl,

wherein x is between 1 and 100. In an aspect, x is 3, 4, or 5. In an aspect, the PEI HCl salt includes linear, branched, or cyclic chains, or any combinations thereof. In an aspect, the PEI HCl salt is formed from a PEI including any of the following structures:

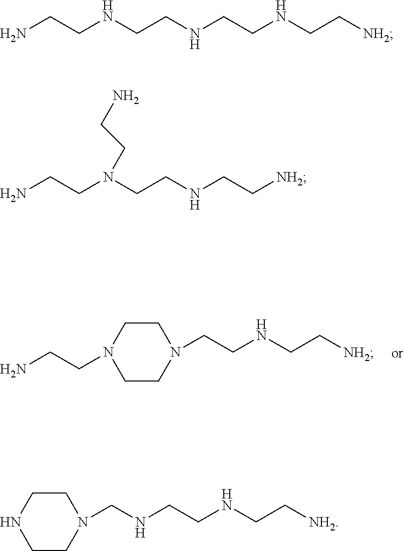 [SMILES: NCCNCCNCCNCCN ; NCCNCCN(CCN)CCN ; NCCNCCN1CCN(CCN)CC1 ; NCCNCCNCN1CCNCC1]

Another embodiment described in examples herein provides a method for making a cement slurry. The method includes reacting a polyethyleneimine (PEI) with hydrochloric acid to form a polyethyleneimine hydrochloride (PEI HCl) salt, dissolving the PEI HCl salt in water to form a PEI HCl salt solution, and mixing the PEI HCl salt solution with cement to form a cement slurry.

In an aspect, the method includes adding a defoamer to the water before adding the PEI HCl salt.

Other implementations are also within the scope of the following claims.

What is claimed is:

1. A method for cementing in a wellbore, comprising:
making a cement slurry by:
reacting a polyethyleneimine (PEI) with hydrochloric acid to form a polyethyleneimine hydrochloride (PEI HCl) salt;
dissolving the PEI HCl salt in water to form a PEI HCl salt solution; and
mixing the PEI HCl salt solution with cement to form a cement slurry;
injecting the cement slurry in a wellbore; and
allowing the cement slurry to set.

2. The method of claim 1, comprising reacting the PEI with a stoichiometric amount of concentrated hydrochloric acid.

3. The method of claim 1, comprising injecting a spacer fluid into the wellbore before the cement slurry.

4. The method of claim 3, comprising adding the PEI HCl salt to the space fluid before injecting the spacer fluid into the wellbore.

5. The method of claim 1, comprising adding potassium chloride to the cement slurry.

6. The method of claim 1, comprising injecting a displacement fluid after the cement slurry.

7. The method of claim 1, comprising placing a wiper plug in the wellbore after the cement slurry and before a displacement fluid.

8. A cement composition for cementing a wellbore, comprising:
a polyethyleneimine hydrochloride (PEI HCl) salt;
an aqueous solvent; and
a cement.

9. The cement composition of claim 8, comprising between about 0.5 wt. % of the PEI HCl salt and about 30 wt. % of the PEI HCl salt.

10. The cement composition of claim 8, comprising between 10 wt. % of the cement and about 90 wt. % of the cement.

11. The cement composition of claim 8, wherein the cement comprises a Portland cement.

12. The cement composition of claim 8, comprising between about 68 wt. % and 69 wt. % of the cement.

13. The cement composition of claim 8, comprising a defoaming agent.

14. The cement composition of claim 8, comprising a polyethyleneimine hydrochloride (PEI HCl) salt having the structural formula:
[H₂NCH₂CH₂(NHCH₂CH₂)ₓNH₂]·HCl,
wherein x is between 1 and 100.

15. The cement composition of claim 14, wherein x is 3, 4, or 5.

16. The cement composition of claim 14, wherein the PEI HCl salt includes linear, branched, or cyclic chains, or any combinations thereof.

17. The cement composition of claim 14, wherein the PEI HCl salt is formed from a PEI comprising any of the following structures:

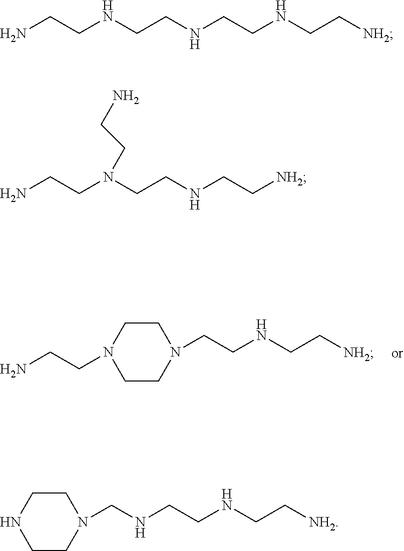 [SMILES: NCCNCCNCCNCCN ; NCCNCCN(CCN)CCN ; NCCNCCN1CCN(CCN)CC1 ; NCCNCCNCN1CCNCC1]

18. A method for making a cement slurry, comprising:
reacting a polyethyleneimine (PEI) with hydrochloric acid to form a polyethyleneimine hydrochloride (PEI HCl) salt;
dissolving the PEI HCl salt in water to form a PEI HCl salt solution; and
mixing the PEI HCl salt solution with cement to form a cement slurry.

19. The method of claim 18, comprising adding a defoamer to the water before adding the PEI HCl salt.
